(19) United States
(12) Patent Application Publication
(10) Pub. No.: US 2021/0295450 A1
(43) Pub. Date: Sep. 23, 2021

(54) INFORMATION PROVIDING SYSTEM

(71) Applicant: HONDA MOTOR CO., LTD., Tokyo (JP)

(72) Inventors: Noboru Kawaguchi, Wako-shi (JP); Masanori Fujinuma, Wako-shi (JP); Sei Watanabe, Wako-shi (JP); Tomoyuki Kuriyama, Tokyo (JP); Yutaka Tsuji, Tokyo (JP)

(21) Appl. No.: 17/204,127

(22) Filed: Mar. 17, 2021

(30) Foreign Application Priority Data
Mar. 19, 2020 (JP) 2020-049377

(51) Int. Cl. G06Q 40/00; G06Q 50/06; G06Q 30/00; G06Q 30/02; G06Q 10/00; A01G 20/00

(52) U.S. Cl. CPC G06Q 40/12; G06Q 50/06; G06Q 30/01; G06Q 30/0645; G06Q 10/30; A01G 20/00; G06Q 30/0283

(57) ABSTRACT

Provided is an information providing system capable of promoting use of services relating to a lawn. An information providing system 1 includes: a gardener terminal 200 that provides gardener information regarding a service relating to a lawn; a customer terminal 300 that is communicably connected to the gardener terminal 200 and provides request information relating to the lawn; and an information providing device 100 that is communicably connected to the gardener terminal 200 and the customer terminal 300. The information providing device 100 includes a gardener information storage unit 121 that stores the gardener information, a gardener information acquiring unit 111 that, upon receiving the request information from the customer terminal 300, refers to the gardener information storage unit 121 and acquires the gardener information matching the request information, and a gardener information transmitting unit 112 that transmits the gardener information acquired by the gardener information acquiring unit 111 to the customer terminal 300.

This application is based on and claims the benefit of priority from Japanese Patent Application No. 2020-049377, filed on 19 Mar. 2020, the content of which is incorporated herein by reference.

### BACKGROUND OF THE INVENTION

### Field of the Invention

The present invention relates to an information providing system.

### Related Art

Conventionally, in order to protect the global environment and effectively utilize resources, various technologies for recycling and reusing plants have been proposed (for example, refer to Japanese Unexamined Patent Application, Publication No. 2005-71343). The technique disclosed in Japanese Patent Application Laid-Open No. 2005-71343 discloses that, in order to promote recycling, the selling price of organic materials made from waste plants is discounted in accordance with the collection fee of waste plants.

Patent Document 1: Japanese Unexamined Patent Application, Publication No. 2005-71343

### SUMMARY OF THE INVENTION

Lawns used in parks, hotels, event halls, golf courses, and the like require periodic maintenance, such as harvesting, watering, and providing of fertilizer. In order to regularly perform such maintenance, a user who uses lawns often requests a gardener (also referred to as a landscape gardener) that provides services relating to lawns such as maintenance to manage the lawns. However, under the conventional method, it is difficult to match a gardener who wants to provide the service relating to the lawns with a user (customer) who wants the service relating to the lawns, and to effectively utilize the service relating to the lawns.

It is, therefore, an object of the present invention to provide an information providing system capable of promoting the use of services relating to a lawn.

An information providing system (for example, an information providing system 1 described later) according to the present invention includes: a gardener terminal (for example, a gardener terminal 200 described later) that provides gardener information regarding a service relating to a lawn; a customer terminal (for example, a customer terminal 300 described later) that is communicably connected to the gardener terminal and provides request information relating to the lawn; and an information providing device (for example, an information providing device 100 described later) that is communicably connected to the gardener terminal and the customer terminal, in which the information providing device includes a gardener information storage unit (for example, a gardener information storage unit 121 described later) that stores the gardener information, a gardener information acquiring unit (for example, a gardener information acquiring unit 111 described later) that, upon receiving the request information from the customer terminal, refers to the gardener information storage unit and acquires the gardener information matching the request information, and a gardener information transmitting unit (for example, a gardener information transmitting unit 112 described later) that transmits the gardener information acquired by the gardener information acquiring unit to the customer terminal.

Furthermore, the information providing device further includes an energy information receiving unit (for example, an energy information receiving unit 113 described later) that, in a case in which a contract of a transaction relating to the lawn is concluded between a customer using the customer terminal and a gardener using the gardener terminal, receives energy information including an energy amount of energy generated by using the lawn produced by a trade relating to the lawn from the gardener terminal with which the contract has been concluded, and a fee information generating unit (for example, a fee information generating unit 114) that generates fee information corresponding to the energy amount and transmits the fee information to the gardener terminal.

Furthermore, the energy information receiving unit receives the energy information including the energy amount of the energy generated by fermenting the lawn produced by the trade relating to the lawn and using a resulting fermented product, from the gardener terminal with which a contract has been concluded.

Furthermore, the fee information includes a predetermined price corresponding to the energy amount, and, in a case in which the energy amount is equal to or greater than the energy amount, the fee information generating unit sets a price obtained by subtracting an amount of money corresponding to the energy amount from the predetermined price.

Furthermore, in a case in which the energy amount is less than the predetermined amount, the fee information generating unit sets a price obtained by adding an amount of money corresponding to the energy amount to the predetermined value.

Furthermore, the gardener information includes a content of a service relating to the lawn by a gardener, a fee for the service relating to the lawn, a variety of the lawn provided by the gardener, a type of fertilizer used for the lawn, a method of treating the lawn produced by a trade relating to the lawn, and energy generated using the lawn.

Furthermore, the request information includes a content of the service relating to the lawn and a fee for the service desired by a customer.

According to the present invention, it is possible to provide an information providing system capable of promoting the use of services relating to a lawn.

### BRIEF DESCRIPTION OF THE DRAWINGS

FIG. 1 is a schematic diagram showing a relationship among a management company, a gardener, and a customer according to the present embodiment;

FIG. 2 is a diagram showing an example of the configuration of an information providing system according to the present embodiment;

FIG. 3 is a diagram showing an example of the configuration of an information providing device; and

FIG. 4 is a flowchart showing a flow of processing of the information providing system.

### DETAILED DESCRIPTION OF THE INVENTION

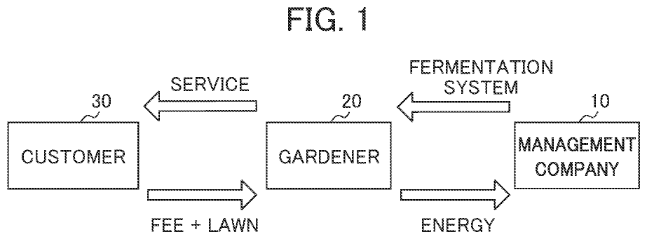

Embodiments of an information providing system of the present invention will be described below with reference to the drawings. FIG. 1 is a schematic diagram showing a relationship among a management company 10, a gardener 20, and a customer 30 according to the present embodiment.

In the present embodiment, the management company 10 provides a fermentation system to the gardener 20 for fermenting the lawn which has been pruned and has become a waste, and generating energy using the fermented product.

The fermentation system includes, for example, a fermentation device, a biogas acquisition device, an energy generating device, and an energy storage device. The fermentation device is a device for fermenting lawns. The biogas acquisition device acquires biogas such as methane gas, carbon monoxide, and carbon dioxide from a fermented product obtained by fermenting lawns. The energy generating device uses biogas to generate hydrogen and energy such as electricity. The energy generating device has, for example, a reformer for generating hydrogen from biogas and a generator for biogas for generating electricity from biogas. The energy storage device stores the generated energy. It should be noted that the fermentation system may be provided with another configuration for fermenting lawns to generate energy from the fermented product.

Such a fermentation system is provided or lent from the management company 10 to the gardener 20 for a fee or free of charge. Furthermore, the management company 10 may perform maintenance of the fermentation system or the like for a fee or free of charge. The management company 10 is supplied with energy generated by the fermentation system from the gardener 20.

The gardener 20 is also referred to as a landscape gardener, and provides the customer 30 with lawn management such as periodic lawn mowing and lawn-related services such as lawn rental. Furthermore, the gardener 20 ferments the waste lawn using the fermentation system provided by the management company 10. Thereafter, the gardener 20 uses a fermentation system to generate energy of hydrogen and electricity from the fermented product.

The gardener 20 grows the lawn in order to provide services relating to the lawn. Thereafter, a used lawn or an unnecessary lawn is used for fermentation as waste. In addition, the gardener 20 may use a solution of fermented lawns or a biogas such as carbon dioxide or the like as fertilizer for growing lawns.

The customer 30 is, for example, a park management company, a hotel, an event management company, a golf course management company, an individual user, or the like, and receives services relating to lawns from the gardener 20. The customer 30 pays a fee to the gardener 20 as a compensation for services relating to lawns. In addition, the customer 30 provides the gardener 20 with lawns, which are waste generated by management of the lawns such as lawn mowing.

As described above, in the present embodiment, the management company 10, the gardener 20, and the customer 30 have a relationship of giving and receiving services relating to lawns, energy generated from fermented lawns, and compensation for them.

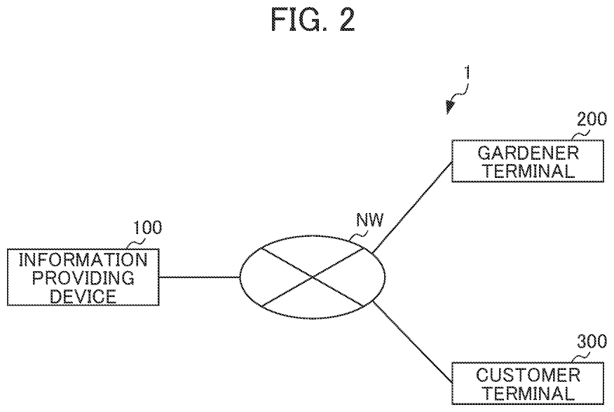

FIG. 2 is a diagram showing an example of a configuration of an information providing system 1 according to the present embodiment. As shown in FIG. 2, the information providing system 1 includes an information providing device 100, a gardener terminal 200, and a customer terminal 300.

The information providing device 100 is used by the management company 10 shown in FIG. 1, and is connected to the gardener terminal 200 and the customer terminal 300 via the network NW so as to be able to communicate with each other.

The gardener terminal 200 is used by the gardener 20 shown in FIG. 1, and is connected to the information providing device 100 and the customer terminal 300 so as to be able to communicate with each other via the network NW. The gardener terminal 200 provides gardener information about services related to lawns to the information providing device 100.

The customer terminal 300 is used by the customer 30 shown in FIG. 1, and is connected to the information providing device 100 and the gardener terminal 200 so as to be able to communicate with each other via the network NW. The customer terminal 300 provides the gardener terminal 200 with request information relating to the lawn.

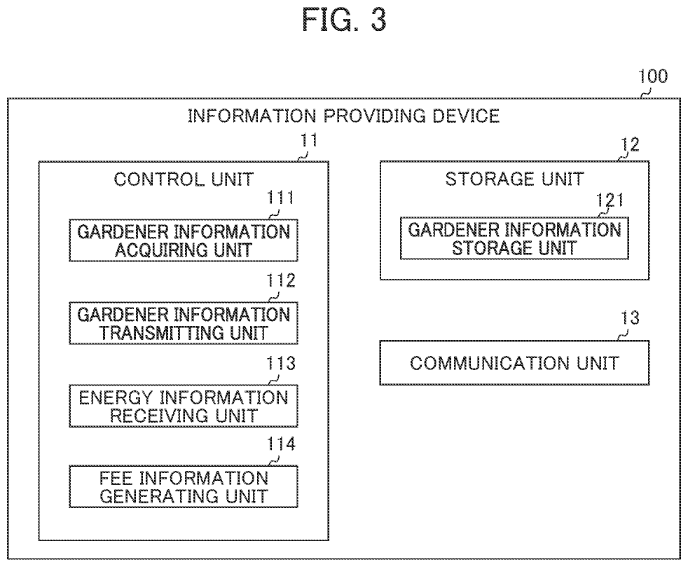

FIG. 3 is a diagram showing an example of a configuration of the information providing device 100. As shown in FIG. 2, the information providing device 100 includes a control unit 11, a storage unit 12, and a communication unit 13.

The control unit 11 is realized by, for example, a hardware processor such as a CPU (Central Processing Unit) executing a program (software). Some or all of these components may be realized by hardware (including a circuit portion) such as an LSI (Large Scale Integration) or an ASIC (Application Specific Integrated Circuit), an FPGA (Field-Programmable Gate Array, or a GPU (Graphics Processing Unit), or may be realized by cooperation of software and hardware. The program may be stored in advance in a storage device such as an HDD (Hard Disk Drive) or flash memory (a storage device including a non-transient storage medium), or may be stored in a removable storage medium such as a DVD or a CD-ROM (a non-transient storage medium) and installed when the storage medium is inserted to drive device.

The storage unit 12 is realized by, for example, a storage device including a non-transient storage medium such as an HDD (Hard Disk Drive), flash memory, EEPROM (Electrically Erasable Programmable Read Only Memory), ROM (Read Only Memory), or the like, or RAM (Random Access Memory).

The communication unit 13 is a communication interface for communicating with external devices such as the gardener terminal 200 and the customer terminal 300 through the network NW.

Next, the processing of the control unit 11 will be described. As shown in FIG. 3, the control unit 11 includes a gardener information acquiring unit 111, a gardener information transmitting unit 112, an energy information receiving unit 113, and a fee information generating unit 114.

Upon receiving request information from the customer terminal 300, the gardener information acquiring unit 111 refers to the gardener information storage unit 121 to acquire gardener information matching the request information.

Here, the request information includes the content of the service and the fee for the service relating to lawns desired by the customer 30. Furthermore, the request information may include lawn varieties provided by the gardener, a type of fertilizer used for the lawn, a method of treating a lawn produced by a trade relating to the lawn, energy generated using the lawn, and the like.

The gardener information storage unit 121 stores gardener information received in advance from the gardener terminal 200. The gardener information includes the content of services relating to the lawn by the gardener, the fee for the services relating to the lawn, the variety of the lawn provided by the gardener, the type of fertilizer used for the lawn, the method of treating the lawn produced by the trade relating to the lawn, and the energy produced using the lawn. In addition, the gardener information may further include information such as a service provision time relating to the lawn, a location of the gardener, and the like.

The gardener information transmitting unit 112 transmits the gardener information acquired by the gardener information acquiring unit 111 to the customer terminal 300. The gardener information transmitted to the customer terminal 300 allows the customer 30 using the customer terminal 300 to determine with which gardener 20 to contract.

The energy information receiving unit 113 receives the energy information including the data of the energy amount of the energy generated using the lawn generated by the transaction relating to the lawn from the gardener terminal 200 when the transaction relating to the lawn is concluded between the customer 30 using the customer terminal 300 and the gardener 20 using the gardener terminal 200. It should be noted that the information providing device 100 generates contract information indicating the conclusion of a contract for a transaction relating to the lawn, and transmits the contract information to the gardener terminal 200 and the customer terminal 300 relating to the transaction relating to the lawn. Furthermore, the contract information may be generated by the gardener terminal 200 and/or the customer terminal 300, and transmitted to the information providing device 100, the gardener terminal 200, and the customer terminal 300 relating to the transaction relating to the lawn.

More specifically, the energy information receiving unit 113 receives, from the gardener terminal 200 with which the contract has been established, energy information including the data of the energy amount of the energy generated by fermenting the lawn generated by the transaction relating to the lawn and using the fermented product.

Here, the transaction relating to the lawn includes providing the customer 30 with, for example, the management of the lawn such as periodic lawn mowing and services relating to the lawn such as rental of the lawn from the gardener 20, and the payment of a fee from the customer 30 to the gardener 20 in compensation of the services relating to the lawn. Furthermore, the energy information includes, for example, data relating to the energy amount and the energy type of the energy generated by using the fermented product.

The fee information generating unit 114 generates fee information according to the energy amount, and transmits the fee information to the gardener terminal 200.

Here, the fee information includes, for example, a predetermined price corresponding to the energy amount, and a commission. Furthermore, when the energy amount is equal to or larger than a predetermined amount, the fee information generating unit 114 sets a price obtained by subtracting the amount corresponding to the energy amount from the predetermined price.

For example, it is assumed that the gardener 20 using the gardener terminal 200 has concluded a contract with the management company 10 using the information providing device 100 to collect 20 kW of electric power every month as electric energy and to pay a predetermined price as a rental fee for the fermentation system.

In this case, the fee information generating unit 114 determines whether the energy amount in the energy information transmitted from the gardener terminal 200 is 20 kW or more every month. Thereafter, the fee information generating unit 114 sets a price obtained by subtracting the amount corresponding to the energy amount exceeding 20 kW from a predetermined price when the energy amount is 20 kW or more every month. That is, the fee information generating unit 114 sets the amount of money corresponding to the energy amount to a price discounted from a predetermined price.

Furthermore, when the energy amount is lower than a predetermined amount, the fee information generating unit 114 sets a price obtained by adding an amount of money corresponding to the energy amount to the predetermined price. For example, the fee information generating unit 114 sets a price obtained by subtracting the amount of money corresponding to the energy amount less than 20 kW from a predetermined price when the energy amount is less than 20 kW every month. That is, the fee information generating unit 114 sets the amount of money corresponding to the energy amount to a price that is increased from a predetermined price.

In addition, when the information providing device 100 sets a price obtained by subtracting or adding the amount of money corresponding to the energy amount from or to a predetermined price, the gardener terminal 200 may update the fee information to be presented to the customer terminal 300 based on the information on the price.

For example, when the information providing device 100 sets a price obtained by subtracting the amount of money corresponding to the energy amount from the predetermined price, the gardener terminal 200 may set the fee to be presented to the customer terminal 300 to a price discounted from the normal price based on the information about the price, and may update the fee information.

Furthermore, energy generated by using the lawn generated by trading relating to the lawn may be sold to a third party other than the management company 10, the gardener 20, or the customer 30. For example, hydrogen and electricity generated using the lawn may be sold to a third party, such as a utility company, a service station providing energy, an individual using energy, etc.

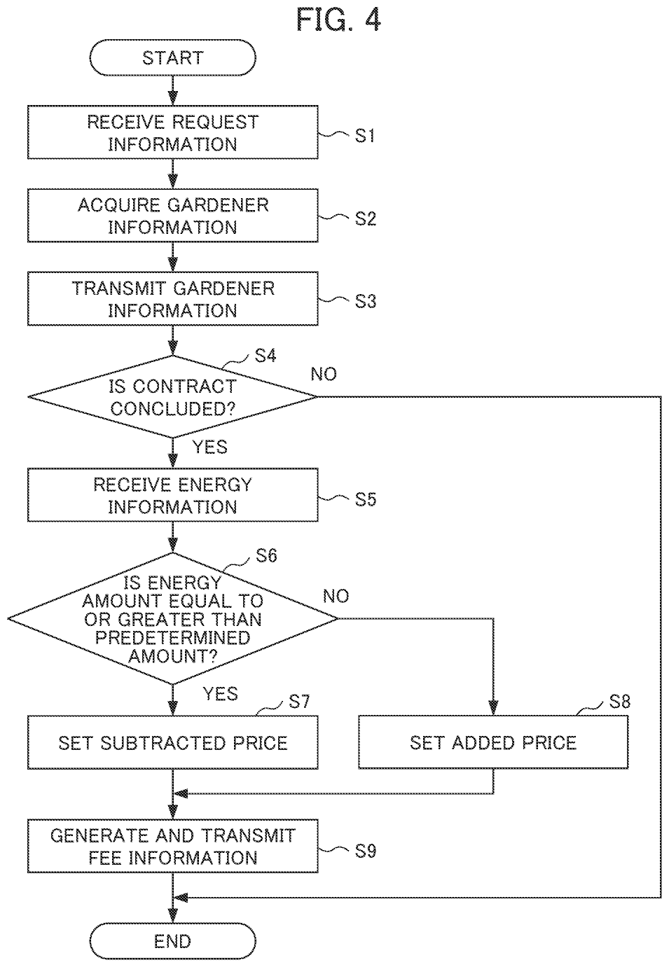

FIG. 4 is a flowchart showing the flow of processing of the information providing system 1. In step S1, the gardener information acquiring unit 111 receives request information from the customer terminal 300. In step S2, upon receiving the request information from the customer terminal 300, the gardener information acquiring unit 111 refers to the gardener information storage unit 121 to acquire gardener information matching the request information.

In step S3, the gardener information transmitting unit 112 transmits the gardener information acquired by the gardener information acquisition unit 111 to the customer terminal 300.

In step S4, the energy information receiving unit 113 determines whether or not a contract for a transaction relating to lawn has been concluded between the customer 30 using the customer terminal 300 and the gardener 20 using the gardener terminal 200. When the contract for the transaction relating to the lawn is concluded (YES), the processing advances to step S5. On the other hand, when the contract for the transaction relating to the lawn is not concluded (NO), the processing ends.

In step S5, the energy information receiving unit 113 receives the energy information including the data of the energy amount of the energy generated by using the lawn produced by the transaction relating to the lawn from the gardener terminal 200 with which the contract has been concluded.

In step S6, the fee information generating unit 114 determines whether or not the energy amount exceeds a predetermined amount. When the energy amount is equal to or greater than the predetermined amount (YES), the processing advances to step S7. On the other hand, when the energy amount is less than the predetermined amount (NO), the processing advances to step S8.

In step S7, the fee information generating unit 114 sets a price obtained by subtracting the amount of money corresponding to the energy amount from a predetermined price. In step S8, the fee information generating unit 114 sets a price obtained by adding the amount of money corresponding to the energy amount to a predetermined price.

In step S9, the fee information generating unit 114 generates fee information including the set price, and transmits the fee information to the gardener terminal 200.

According to the present embodiment, for example, the following effects can be achieved. The information providing system 1 includes: the gardener terminal 200 that provides gardener information regarding a service relating to a lawn; the customer terminal 300 that is communicably connected to the gardener terminal 200 and provides request information relating to the lawn; and the information providing device 100 that is communicably connected to the gardener terminal 200 and the customer terminal 300.

The information providing device 100 includes the gardener information storage unit 121 that stores the gardener information, the gardener information acquiring unit 111 that, upon receiving the request information from the customer terminal 300, refers to the gardener information storage unit 121 and acquires the gardener information matching the request information, and the gardener information transmitting unit 112 that transmits the gardener information acquired by the gardener information acquiring unit 111 to the customer terminal 300.

As a result, the information providing system 1 can match the gardener terminal 200 that provides gardener information about services relating to the lawn with the customer terminal 300 that provides request information about the lawn, and can promote the use of services relating to the lawn between the gardener 20 that uses the gardener terminal 200 and the customer 30 that uses the customer terminal 300.

Furthermore, the information providing device 100 further includes the energy information receiving unit 113 that, in a case in which a contract of a transaction relating to the lawn is concluded between the customer 30 using the customer terminal 300 and the gardener 20 using the gardener terminal 200, receives energy information including data of an energy amount of energy generated by using the lawn produced by a trade relating to the lawn from the gardener terminal 200 with which the contract has been concluded, and the fee information generating unit 114 that generates fee information corresponding to the energy amount and transmits the fee information to the gardener terminal 114. As a result, the information providing system 1 can appropriately carry out transactions relating to the lawn between the customer 30 using the customer terminal 300 and the gardener 20 using the gardener terminal 200.

Furthermore, the energy information receiving unit 113 receives the energy information including the energy amount of the energy generated by fermenting the lawn produced by the trade relating to the lawn and using a resulting fermented product, from the gardener terminal 200 with which a contract has been concluded. As a result, the information providing system 1 can establish the energy generated using the fermented product obtained by fermenting the lawn as a target of the trade relating to the lawn.

Furthermore, the fee information includes a predetermined price corresponding to the energy amount, and, in a case in which the energy amount is equal to or greater than the energy amount, the fee information generating unit 114 sets a price obtained by subtracting an amount of money corresponding to the energy amount from the predetermined price. As a result, when the energy amount is equal to or larger than the predetermined amount, the information providing system 1 can set the amount of money corresponding to the energy amount at a discounted price from the predetermined price.

In a case in which the energy amount is less than the predetermined amount, the fee information generating unit 114 sets a price obtained by adding an amount of money corresponding to the energy amount to the predetermined value. As a result, when the energy amount is lower than the predetermined amount, the information providing system 1 can set the amount of money corresponding to the energy amount to a price that is increased from the predetermined price.

The gardener information includes a content of a service relating to the lawn by a gardener, a fee for the service relating to the lawn, a variety of the lawn provided by the gardener, a type of fertilizer used for the lawn, a method of treating the lawn produced by a trade relating to the lawn, and energy generated using the lawn. As a result, the information providing device 100 can provide the customer terminal 300 with appropriate information about the transaction relating to the lawn.

Furthermore, the request information includes a content of the service relating to the lawn and a fee for the service desired by a customer. As a result, the customer terminal 300 can provide the information providing device 100 with appropriate information about the transaction relating to the lawn.

While an embodiment of the present invention has been described above, the present invention is not intended to be limited thereto. Within the spirit of the present invention, the details of the configuration may be modified as appropriate.

### EXPLANATION OF REFERENCE NUMERALS

1 information service system
11 control unit
12 storage unit
13 communication unit
111 gardener information acquiring unit
112 gardener information transmitting unit
113 energy information receiving unit
114 fee information generating unit
100 information providing device
200 gardener terminal
300 customer terminal

What is claimed is:

1. An information providing system comprising:
a gardener terminal that provides gardener information regarding a service relating to a lawn;
a customer terminal that is communicably connected to the gardener terminal and provides request information relating to the lawn; and
an information providing device that is communicably connected to the gardener terminal and the customer terminal,
wherein the information providing device includes
a gardener information storage unit that stores the gardener information,
a gardener information acquiring unit that, upon receiving the request information from the customer terminal, refers to the gardener information storage unit and acquires the gardener information matching the request information, and
a gardener information transmitting unit that transmits the gardener information acquired by the gardener information acquiring unit to the customer terminal.

2. The information providing system according to claim 1,
wherein the information providing device further includes an energy information receiving unit that, in a case in which a contract of a transaction relating to the lawn is concluded between a customer using the customer terminal and a gardener using the gardener terminal, receives energy information including data of an energy amount of energy generated by using the lawn produced by a trade relating to the lawn from the gardener terminal with which the contract has been concluded, and
a fee information generating unit that generates fee information corresponding to the energy amount and transmits the fee information to the gardener terminal.

3. The information providing system according to claim 2, wherein the energy information receiving unit receives the energy information including the energy amount of the energy generated by fermenting the lawn produced by the trade relating to the lawn and using a resulting fermented product, from the gardener terminal with which a contract has been concluded.

4. The information providing system according to claim 2, wherein the fee information includes a predetermined price corresponding to the energy amount, and
in a case in which the energy amount is equal to or greater than the energy amount, the fee information generating unit sets a price obtained by subtracting an amount of money corresponding to the energy amount from the predetermined price.

5. The information providing system according to claim 4, wherein, in a case in which the energy amount is less than the predetermined amount, the fee information generating unit sets a price obtained by adding an amount of money corresponding to the energy amount to the predetermined value.

6. The information providing system according to claim 1, wherein the gardener information includes a content of a service relating to the lawn by a gardener, a fee for the service relating to the lawn, a variety of the lawn provided by the gardener, a type of fertilizer used for the lawn, a method of treating the lawn produced by a trade relating to the lawn, and energy generated using the lawn.

7. The information providing system according to claim 1, wherein the request information includes a content of the service relating to the lawn and a fee for the service desired by a customer.
